(19) United States
(12) Patent Application Publication
(10) Pub. No.: US 2026/0070308 A1
(43) Pub. Date: Mar. 12, 2026

(54) USING TITANIUM DIOXIDE NANOFIBERS TO CREATE AIR-CLEANING AND DUST-PROOF WINDOWS

(71) Applicant: Clearchang, Jeonju-si (KR)

(72) Inventors: Do Kyoung KIM, Jeonju-si (KR); Tae Woong CHAE, Jeonju-si (KR); Hee Jae SHIN, Jeonju-si (KR)

(21) Appl. No.: 18/929,438

(22) Filed: Oct. 28, 2024

(30) Foreign Application Priority Data
Sep. 11, 2024 (KR) 10-2024-0123596

(51) Int. Cl. B32B 5/26; B01D 39/08; B01D 39/16; B01D 39/20; B32B 5/02; D03D 15/275; D03D 15/283; D03D 15/292; D04H 1/4318; D04H 1/4382; D04H 1/728

(52) U.S. Cl. CPC B32B 5/275; B01D 39/083; B01D 39/1623; B01D 39/2027; B32B 5/022; B32B 5/024; D03D 15/275; D03D 15/283; D03D 15/292; D04H 1/4318; D04H 1/43838; D04H 1/728; B01D 2239/025; B01D 2239/0613; B01D 2239/0631; B01D 2239/065; B32B 2250/20; B32B 2262/0238; B32B 2262/0284; B32B 2262/106; B32B 2262/128; B32B 2264/1022; B32B 2307/3065; B32B 2307/412; B32B 2307/718; B32B 2307/724; B32B 2419/00; D10B 2321/041; D10B 2321/042; D10B 2321/10; D10B 2331/04; D10B 2503/00; D10B 2505/04

(57) ABSTRACT

The present inventive concept relates to an air purification and nano dustproof window screen that is made of titanium dioxide nanofibers, more specifically to a titanium dioxide-filled nano dustproof window screen that is capable of blocking external pollutants such as fine dust, ultrafine dust, and yellow dust, having excellent air ventilation, flame-resistant performance, NOx removal efficiency, and visible light transmittance.

### TECHNICAL FIELD

The present inventive concept relates to an air purification and nano dustproof window screen that is made of titanium dioxide nanofibers, more specifically to a titanium dioxide-filled nano dustproof window screen that is capable of blocking external pollutants such as fine dust, ultrafine dust, and yellow dust, while having excellent air ventilation, flame-resistant performance, nitrogen oxides (NOx) removal efficiency, and visible light transmittance.

### BACKGROUND ART

Generally, an insect screen is mounted on a window of a residential building such as a house, an apartment, and the like to provide protection against pests such as mosquitoes, flies, and the like, along with increased ventilation. The insect screen is made of synthetic fibers such as nylon, polyester, and the like, and otherwise, the insect screen is made of a metal such as aluminum, stainless steel, and the like. Further, the insect screen is recently made of glass fibers. Like this, insect screen products made of various types of materials have been developed and widely used. However, as the number of times that harmful fine (ultrafine) dust enters a house through existing insect screens has recently increased, the possibility that respiratory diseases due to the fine dust occur becomes high, and therefore, it is reluctant to safely perform air ventilation through window opening, only with the existing insect screen. That is, it is necessary to perform air ventilation, while living in a house, to provide protection from asbestos, radon, germs, and formaldehyde generated indoors and various types of indoor air pollutants generated during cooking, uses of electronic devices, etc., but it is avoided to perform the air ventilation because external harmful materials such as fine dust may enter the house.

Therefore, there is a definite need to develop a new insect and dustproof screen that is capable of providing insect protection and further preventing harmful fine dust from entering a house.

### PRIOR ART LITERATURE

### Patent Literature

(Patent Literature 0001) Korean Patent No. 2019-0110963 (Dated on Oct. 1, 2019)

### DISCLOSURE

### Technical Problem

To solve the above-mentioned problems occurring in the related art, accordingly, it is an object of the present inventive concept to provide a titanium dioxide-filled nano dustproof window screen that is capable of having excellent dust collection efficiency, air ventilation, flame-resistant performance, NOx removal efficiency, and visible light transmittance.

### Technical Solution

To accomplish the above-mentioned objects, according to the present inventive concept, there is provided a titanium dioxide-filled nano dustproof window screen including a first fabric, a nanofiber web, and a second fabric laminated on top of one another, wherein the nanofiber web may include polyvinylidene fluoride and reduced titanium dioxide.

According to a desirable embodiment of the present inventive concept, the nanofiber web may include the polyvinylidene fluoride and the reduced titanium dioxide mixed by weight in the ratio of 1:0.05 to 0.3.

According to a desirable embodiment of the present inventive concept, the first fabric may be made of polyacrylonitrile (PAN) carbon fibers coated with polyvinyl chloride having a weight-average molecular weight in the range between 38,000 and 58,000 in such a way as to be woven to have a square mesh pattern.

According to a desirable embodiment of the present inventive concept, the first fabric may have an opening rate of 55 to 75%.

According to a desirable embodiment of the present inventive concept, the second fabric may have an opening rate of 25 to 45%.

According to a desirable embodiment of the present inventive concept, the nanofiber web may have a gram per square meter of 10 to 20 g/m² and an average diameter of 150 to 350 nm.

According to a desirable embodiment of the present inventive concept, the first fabric may have a gram per square meter of 25 to 35 g/m².

According to a desirable embodiment of the present inventive concept, the second fabric may have a gram per square meter of 15 to 25 g/m².

In the present inventive concept, a term ‘fibers’ is referred to as yarns or threads, which means various types of typical yarns and threads.

### Effective Advantages of the Inventive Concept

According to the present inventive concept, the titanium dioxide-filled nano dustproof window screen has excellent dust collection efficiency and air ventilation.

Further, the titanium dioxide-filled nano dustproof window screen has excellent flame-resistant performance, NOx removal efficiency, and visible light transmittance.

### DESCRIPTION OF DRAWINGS

FIG. 1 is a sectional view showing a titanium dioxide-filled nano dustproof window screen according to the present inventive concept.

FIG. 2 is a top view showing a first fabric having a square mesh pattern in the titanium dioxide-filled nano dustproof window screen according to the present inventive concept.

FIG. 3 is a top view showing a second fabric having a hexagonal mesh pattern in the titanium dioxide-filled nano dustproof window screen according to the present inventive concept.

FIG. 4 is a microscopic image of the first fabric prepared in a first embodiment of the present inventive concept.

FIG. 5 is a microscopic image of a nanofiber web manufactured in the first embodiment of the present inventive concept.

FIG. 6 is an image of a process of forming the nanofiber web on one surface of the first fabric where a polymer solution is prepared through electrospinning in the first embodiment of the present inventive concept.

FIG. 7 is an SEM image of the first fabric prepared in the first embodiment of the present inventive concept.

FIG. 8 is an SEM image of the nanofiber web manufactured in the first embodiment of the present inventive concept.

### MODE FOR INVENTIVE CONCEPT

Hereinafter, an embodiment of the present inventive concept will be described in detail with reference to the attached drawings so that it may be carried out easily by those having ordinary skill in the art. Before the present inventive concept is disclosed and described, it is to be understood that the disclosed embodiments are merely exemplary of the inventive concept, which can be embodied in various forms. Also, in explaining the example embodiments, detailed description on known elements or functions will be omitted if it is determined that such description will interfere with understanding of the embodiments. For reference numerals, with respect to the same elements, even though they may be displayed in different drawings, such elements use same reference numerals as much as possible.

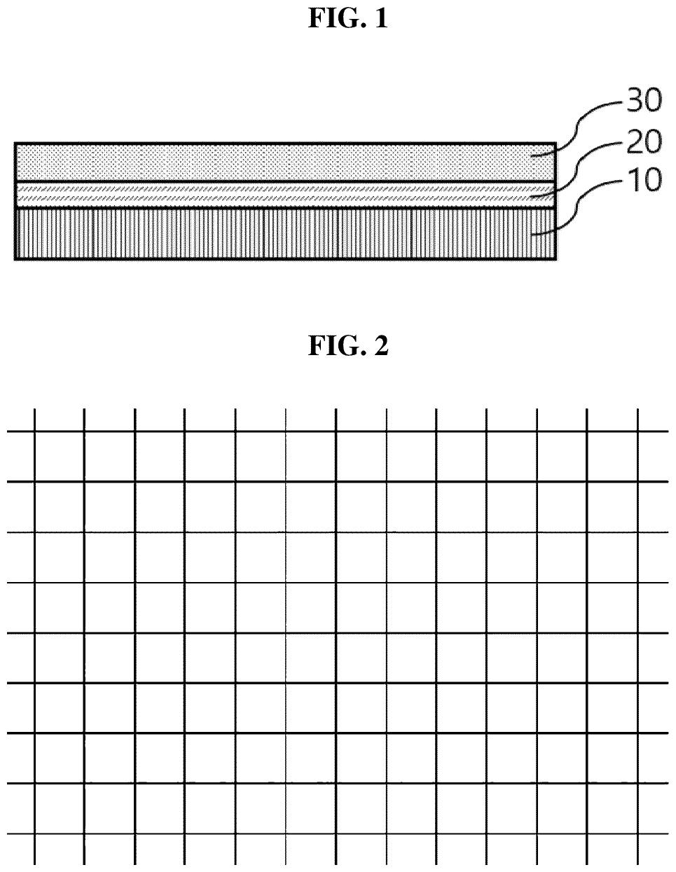

Referring to FIG. 1, a titanium dioxide-filled nano dustproof window screen according to the present inventive concept is configured to allow a first fabric 10, a nanofiber web 20, and a second fabric 30 to be laminated on top of one another.

First, as shown in FIG. 2, the first fabric 10 is made of polyacrylonitrile (PAN) carbon fibers coated with polyvinyl chloride having a weight-average molecular weight in the range between 38,000 and 58,000, desirably 43,000 and 53,000 in such a way as to be woven to have a square mesh pattern. In this case, as the range of the weight-average molecular weight of the polyvinyl chloride is satisfied, excellent dust collection efficiency, air ventilation, flame-resistant performance, NOx removal efficiency, and visible light transmittance are all obtained.

The carbon fibers are polyacrylonitrile (PAN) carbon fibers, rayon carbon fibers, or petroleum pitch carbon fibers, and desirably, they are PAN carbon fibers. The PAN carbon fibers are fabricated by carbonizing PAN fibers obtained by polymerizing and spinning acrylonitrile at a high temperature, and accordingly, they are fibers fabricated by means of polymerization, spinning, and calcination. The polymerization is a process of applying heat and pressure to acrylonitrile (AN) to make the AN to a state of a polymer, the spinning is a process of allowing the PAN obtained through the polymerization to be born again as acrylic fibers, and the calcination is a process of oxidizing and carbonizing the acrylic fibers at a high temperature of 1,200° C. or above. Finally, carbon (C) components remain in the acrylic fibers passing through the calcination, thereby fabricating the PAN carbon fibers.

Further, the PAN carbon fibers range from 1 to 5 denier, desirably 2 to 3 denier.

Furthermore, the first fabric 10 has a gram per square meter of 25 to 35 g/m², desirably 28 to 32 g/m².

Further, the first fabric 10 has an opening rate of 55 to 75%, desirably 60 to 70%, and if the opening rate of the first fabric 10 is not satisfied, excellent dust collection efficiency, air ventilation, flame-resistant performance, NOx removal efficiency, and visible light transmittance are not obtained.

Next, the nanofiber web 20 is formed by applying a polymer solution on one surface of the first fabric 10 by means of electrospinning. The nanofiber web 20 is a collection of fibers having pores formed on outer and/or inner surfaces thereof, and the fibers constituting the nanofiber web 20 have average diameters of 150 to 350 nm, desirably 200 to 300 nm.

Further, the nanofiber web 20 includes polyvinylidene fluoride and reduced titanium dioxide.

The reduced titanium dioxide is fabricated by reducing titanium dioxide and has a blue color. In detail, the reduced titanium dioxide is fabricated by putting lithium (Li) and titanium dioxide into an ethylenediamine solvent, agitating a mixture at conditions of nitrogen and a temperature of 20 to 30° C. for 4 to 8 days to make a reactant, neutralizing the reactant with hydrochloric acid.

In detail, the nanofiber web 20 includes polyvinylidene fluoride and reduced titanium dioxide mixed by weight in the ratio of desirably 1:0.05 to 0.3, more desirably 1:0.06 to 0.2, and most desirably 1:0.08 to 0.13. If such a weight ratio is not satisfied, excellent dust collection efficiency, air ventilation, flame-resistant performance, NOx removal efficiency, and visible light transmittance are not obtained.

Furthermore, the nanofiber web 20 has a gram per square meter of 10 to 20 g/m², desirably 13 to 17 g/m².

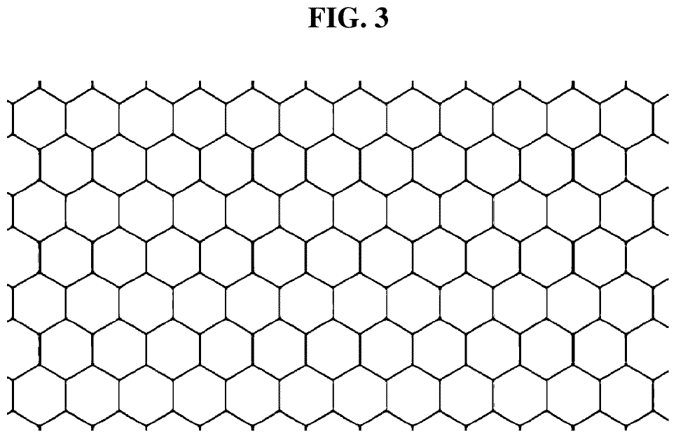

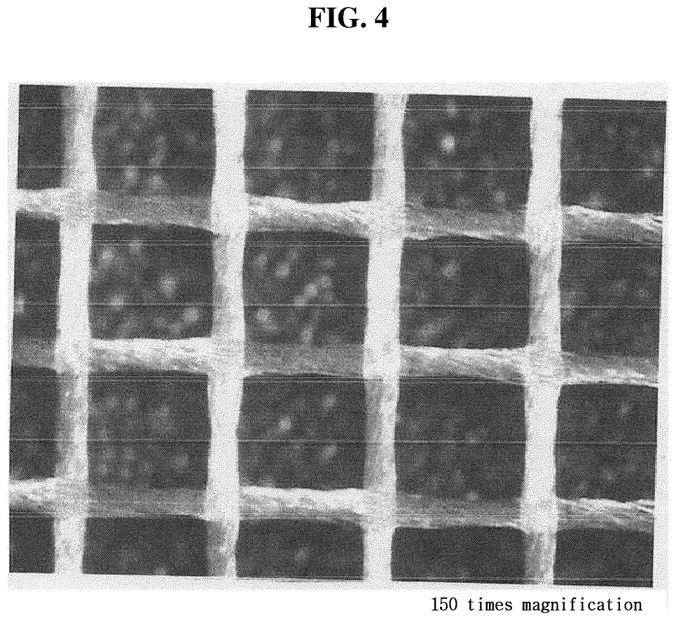

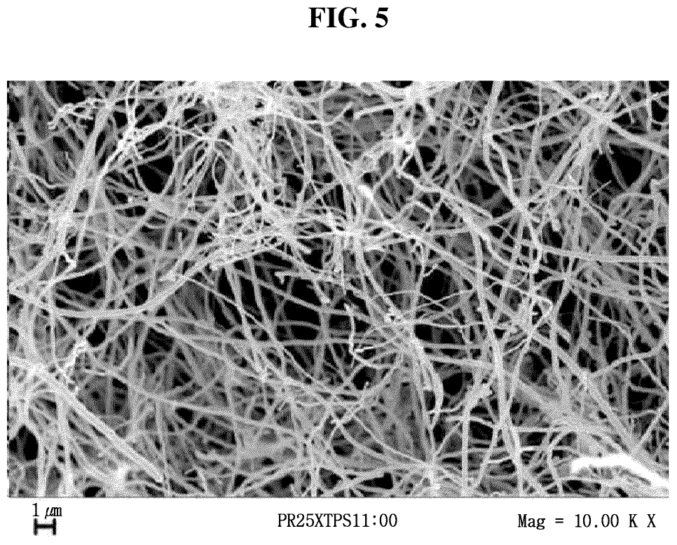

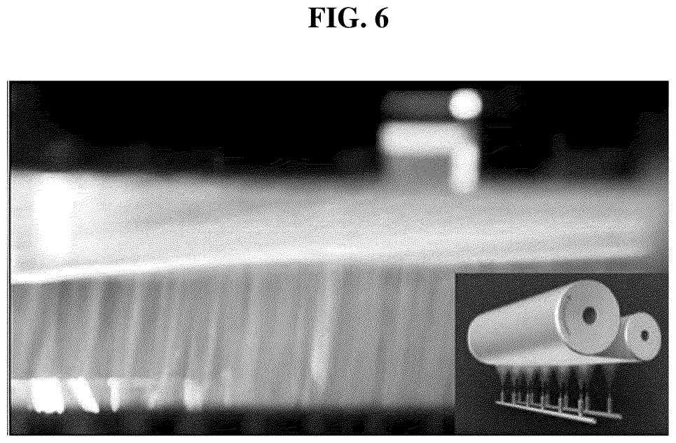

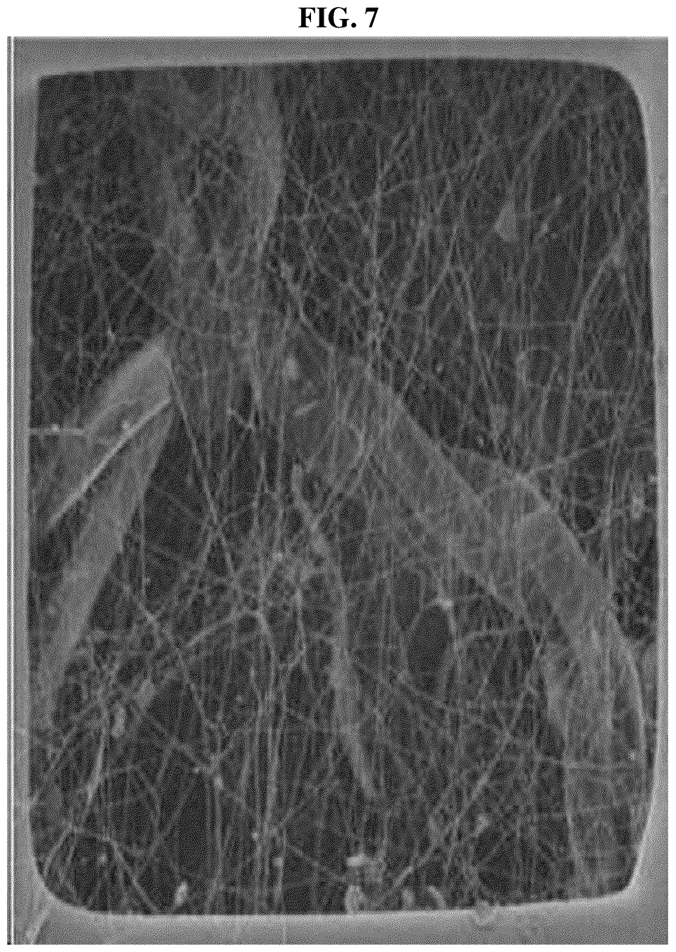

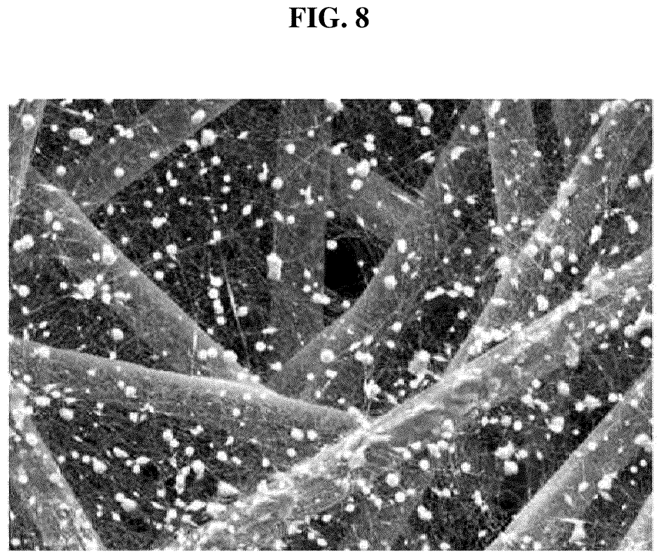

Further, the second fabric 30 is laminated on one surface of the nanofiber web 20, and as shown in FIG. 3, the second fabric 30 is made of polyethylene terephthalate (PET) fibers woven to have a hexagonal mesh pattern.

Further, the PET fibers range from 0.5 to 2.5 denier, desirably 1 to 2 denier.

Furthermore, the second fabric 30 has a gram per square meter of 15 to 25 g/m², desirably 18 to 22 g/m².

Further, the second fabric 30 has an opening rate of 25 to 45%, desirably 30 to 40%, and if the opening rate of the second fabric 30 is not satisfied, excellent dust collection efficiency, air ventilation, flame-resistant performance, NOx removal efficiency, and visible light transmittance are not obtained.

Next, a method for making the titanium dioxide-filled nano dustproof window screen according to the present inventive concept includes first to third steps.

First, the first step in the method for making the titanium dioxide-filled nano dustproof window screen according to the present inventive concept is carried out through the preparation of a first fabric. In this case, the first fabric prepared in the first step is the same as mentioned above.

After that, the second step in the method for making the titanium dioxide-filled nano dustproof window screen according to the present inventive concept is carried out by offering a polymer solution to one surface of the first fabric prepared in the first step by means of electrospinning to produce a nanofiber web. In this case, the nanofiber web is the same as mentioned above.

Further, the polymer solution is fabricated by putting polyvinylidene fluoride and reduced titanium dioxide in a solvent in which dimethylformamide and acetone are mixed by weight in the ratio of 1:0.8 to 1.2.

Lastly, the third step in the method for making the titanium dioxide-filled nano dustproof window screen according to the present inventive concept is carried out by laminating a second fabric woven with PET fibers to a hexagonal mesh pattern on one surface of the nanofiber web fabricated in the second step to thus make the titanium dioxide-filled nano dustproof window screen. In this case, the second fabric is the same as mentioned above. Further, the lamination is performed by stacking the second fabric on one surface of the nanofiber web and passing a fusion roller over the stacked second fabric, and for the lamination, a binder resin such as a polyurethane resin, which is generally used in the art, is applied to the stacked surface of the second fabric.

### Preparation Example 1: Manufacturing Reduced Titanium Dioxide

350 mg lithium (Li) and 500 mg titanium dioxide (Dried TiO₂ nano crystal) with an average particle size of 21 nm were put into a 50 mL ethylenediamine solvent, and next, a mixture was agitated at conditions of nitrogen and a room temperature (25° C.) for six days to manufacture a reactant. The reactant was neutralized with hydrochloric acid, mixed with water through a centrifuge, and purified and filtered, thereby obtaining solid powder. The solid powder was dried in a vacuum oven for one day to manufacture reduced titanium dioxide.

### Embodiment 1: Fabricating Titanium Dioxide-Filled Nano Dustproof Window Screen

(A) Polyacrylonitrile (PAN) carbon fibers (with 3.0 denier) coated with polyvinyl chloride having a weight-average molecular weight of 48,000 were prepared. The prepared PAN carbon fibers were woven to have a square mesh pattern, thereby preparing a first fabric having a gram per square meter of 30 g/m² and an opening rate of 65%.

(B) A polymer solution into which polyvinylidene fluoride and the reduced titanium dioxide manufactured in the preparation example 1 were put in a solvent in which dimethylformamide and acetone were mixed by weight in the ratio of 1:1 was prepared, and next, the polymer solution was offered to one surface of the prepared first fabric by means of electrospinning, thereby producing a nanofiber web having a gram per square meter of 15 g/m² and an average diameter of 250 nm. In this case, the polyvinylidene fluoride and the reduced titanium dioxide manufactured in the preparation example 1 were put by weight in the ratio of 1:0.1.

(C) Polyethylene terephthalate (PET) fibers (with 1.5 denier) were woven to have a hexagonal mesh pattern, thereby preparing a second fabric having a gram per square meter of 20 g/m² and an opening rate of 35%. After the second fabric was stacked on one surface of the nanofiber web, a fusion roller passed over the second fabric, thereby fabricating a titanium dioxide-filled nano dustproof window screen.

### Embodiment 2: Fabricating Titanium Dioxide-Filled Nano Dustproof Window Screen

(A) Polyacrylonitrile (PAN) carbon fibers (with 3.0 denier) coated with polyvinyl chloride having a weight-average molecular weight of 48,000 were prepared. The prepared PAN carbon fibers were woven to have a square mesh pattern, thereby preparing a first fabric having a gram per square meter of 30 g/m² and an opening rate of 65%.

(B) A polymer solution in which polyvinylidene fluoride and the reduced titanium dioxide manufactured in the preparation example 1 were put in a solvent in which dimethylformamide and acetone were mixed by weight in the ratio of 1:1 was prepared, and next, the polymer solution was offered to one surface of the prepared first fabric by means of electrospinning, thereby producing a nanofiber web having a gram per square meter of 15 g/m² and an average diameter of 250 nm. In this case, the polyvinylidene fluoride and the reduced titanium dioxide manufactured in the preparation example 1 were put by weight in the ratio of 1:0.5.

(C) Polyethylene terephthalate (PET) fibers (with 1.5 denier) were woven to have a hexagonal mesh pattern, thereby preparing a second fabric having a gram per square meter of 20 g/m² and an opening rate of 35%. After the second fabric was stacked on one surface of the nanofiber web, a fusion roller passed over the second fabric, thereby fabricating a titanium dioxide-filled nano dustproof window screen.

### Embodiment 3: Fabricating Titanium Dioxide-Filled Nano Dustproof Window Screen

(A) Polyacrylonitrile (PAN) carbon fibers (with 3.0 denier) were prepared. The prepared PAN carbon fibers were woven to have a square mesh pattern, thereby preparing a first fabric having a gram per square meter of 30 g/m² and an opening rate of 65%.

(B) A polymer solution in which polyvinylidene fluoride and the reduced titanium dioxide manufactured in the preparation example 1 were put in a solvent in which dimethylformamide and acetone were mixed by weight in the ratio of 1:1 was prepared, and next, the polymer solution was offered to one surface of the prepared first fabric by means of electrospinning, thereby producing a nanofiber web having a gram per square meter of 15 g/m² and an average diameter of 250 nm. In this case, the polyvinylidene fluoride and the reduced titanium dioxide manufactured in the preparation example 1 were put by weight in the ratio of 1:0.1.

(C) Polyethylene terephthalate (PET) fibers (with 1.5 denier) were woven to have a hexagonal mesh pattern, thereby preparing a second fabric having a gram per square meter of 20 g/m² and an opening rate of 35%. After the second fabric was stacked on one surface of the nanofiber web, a fusion roller passed over the second fabric, thereby fabricating a titanium dioxide-filled nano dustproof window screen.

### Embodiment 4: Fabricating Titanium Dioxide-Filled Nano Dustproof Window Screen

(A) Polyacrylonitrile (PAN) carbon fibers (with 3.0 denier) coated with polyvinyl chloride having a weight-average molecular weight of 30,000 were prepared. The prepared PAN carbon fibers were woven to have a square mesh pattern, thereby preparing a first fabric having a gram per square meter of 30 g/m² and an opening rate of 65%.

(B) A polymer solution in which polyvinylidene fluoride and the reduced titanium dioxide manufactured in the preparation example 1 were put in a solvent in which dimethylformamide and acetone were mixed by weight in the ratio of 1:1 was prepared, and next, the polymer solution was offered to one surface of the prepared first fabric by means of electrospinning, thereby producing a nanofiber web having a gram per square meter of 15 g/m² and an average diameter of 250 nm. In this case, the polyvinylidene fluoride and the reduced titanium dioxide manufactured in the preparation example 1 were put by weight in the ratio of 1:0.1.

(C) Polyethylene terephthalate (PET) fibers (with 1.5 denier) were woven to have a hexagonal mesh pattern, thereby preparing a second fabric having a gram per square meter of 20 g/m² and an opening rate of 35%. After the second fabric was stacked on one surface of the nanofiber web, a fusion roller passed over the second fabric, thereby fabricating a titanium dioxide-filled nano dustproof window screen.

### Embodiment 5: Fabricating Titanium Dioxide-Filled Nano Dustproof Window Screen

(A) Polyacrylonitrile (PAN) carbon fibers (with 3.0 denier) coated with polyvinyl chloride having a weight-average molecular weight of 65,000 were prepared. The prepared PAN carbon fibers were woven to have a square mesh pattern, thereby preparing a first fabric having a gram per square meter of 30 g/m² and an opening rate of 65%.

(B) A polymer solution in which polyvinylidene fluoride and the reduced titanium dioxide manufactured in the preparation example 1 were put in a solvent in which dimethylformamide and acetone were mixed by weight in the ratio of 1:1 was prepared, and next, the polymer solution was offered to one surface of the prepared first fabric by means of electrospinning, thereby producing a nanofiber web having a gram per square meter of 15 g/m² and an average diameter of 250 nm. In this case, the polyvinylidene fluoride and the reduced titanium dioxide manufactured in the preparation example 1 were put by weight in the ratio of 1:0.1.

(C) Polyethylene terephthalate (PET) fibers (with 1.5 denier) were woven to have a hexagonal mesh pattern, thereby preparing a second fabric having a gram per square meter of 20 g/m² and an opening rate of 35%. After the second fabric was stacked on one surface of the nanofiber web, a fusion roller passed over the second fabric, thereby fabricating a titanium dioxide-filled nano dustproof window screen.

### Comparison Example 1: Fabricating Titanium Dioxide-Filled Nano Dustproof Window Screen

(A) Polyacrylonitrile (PAN) carbon fibers coated with polyvinyl chloride having a weight-average molecular weight of 48,000 were prepared. The prepared PAN carbon fibers were woven to have a square mesh pattern, thereby preparing a first fabric having a gram per square meter of 30 g/m² and an opening rate of 65%.

(B) A polymer solution in which polyvinylidene fluoride and the reduced titanium dioxide manufactured in the preparation example 1 were put in a solvent in which dimethylformamide and acetone were mixed by weight in the ratio of 1:1 was prepared, and next, the polymer solution was offered to one surface of the prepared first fabric by means of electrospinning, thereby producing a nanofiber web having a gram per square meter of 15 g/m² and an average diameter of 250 nm.

(C) Polyethylene terephthalate (PET) fibers (with 1.5 denier) were woven to have a hexagonal mesh pattern, thereby preparing a second fabric having a gram per square meter of 20 g/m² and an opening rate of 35%. After the second fabric was stacked on one surface of the nanofiber web, a fusion roller passed over the second fabric, thereby fabricating a titanium dioxide-filled nano dustproof window screen.

### Experimental Example 1

The physical properties as will be discussed later for the titanium dioxide-filled nano dustproof window screens fabricated through the first to fifth embodiments and the first comparison example are measured and listed in Table 1.

### 1. Air Ventilation

Based on a JIS L 1096:2010 test method (test area: 38 cm² and pressure difference: 125 Pa), air ventilation for the titanium dioxide-filled nano dustproof window screens fabricated through the first to fifth embodiments and the first comparison example is measured and listed in Table 1.

### 2. Dust Collection Efficiency

Based on ASHRAE Standard, American Filter Institute (Test wind velocity: 1.0 m/s, final pressure loss: 76 mmAq, test dust: nominal 0 to 10 micron Arizona test dust), dust collection efficiencies for the titanium dioxide-filled nano dustproof window screens fabricated through the first to fifth embodiments and the first comparison example are measured and listed in Table 1.

### 3. Flame-Resistant Performance

Based on No. 2022-29 of National fire agency notice and micro burner rule (Sample division: thin fabric (having 450 g/m² or under, combustion form: carbonization), flame-resistant performance for the titanium dioxide-filled nano dustproof window screens fabricated through the first to fifth embodiments and the first comparison example is measured and listed in Table 1.

### 4. NOx Removal Efficiency

Based on KS L ISO 22197-1 rule (Sample pre-treatment: UV light (2 mW/cm²) radiation for 16 hours before test, light radiation condition: Philips Tl-d Actinic BL 1 mW/cm² (for five hours), test gas flow rate: 3 L/min), NOx removal efficiencies for the titanium dioxide-filled nano dustproof window screens fabricated through the first to fifth embodiments and the first comparison example are measured and listed in Table 1.

### 5. Visible Light Transmittance

Based on FITI TM F 0008:2022 rule (Wavelength range: 380 to 780 nm, wavelength distance: 10 nm), visible light transmittances for the titanium dioxide-filled nano dustproof window screens fabricated through the first to fifth embodiments and the first comparison example are measured and listed in Table 1.

TABLE 1

| | | Embodi- | Embodi- | Embodi- | Embodi- | Embodi- | Comparison |
|---|---|---|---|---|---|---|---|
| | | Ment | Ment | Ment | Ment | Ment | Example |
| Division | | 1 | 2 | 3 | 4 | 5 | 1 |
| Air ventilation | | 474.0 | 438.4 | 471.0 | 473.0 | 466.8 | 471.7 |
| (cm²/s) | | | | | | | |
| Dust collection | | 88.0 | 88.5 | 87.8 | 87.9 | 87.7 | 64.3 |
| efficiency (%) | | | | | | | |
| Flame- | After- | 0 | 0 | 8 | 6 | 4 | 0 |
| retardant | flame | | | | | | |
| performance | time (s) | | | | | | |
| | After- | 0 | 0 | 12 | 10 | 7 | 0 |
| | glow time | | | | | | |
| | (s) | | | | | | |
| | Char | 17.5 | 17.5 | 34.0 | 29.4 | 25.3 | 17.6 |
| | area | | | | | | |
| | (cm²) | | | | | | |
| | Char | 6.7 | 6.7 | 18.4 | 15.8 | 10.4 | 6.9 |
| | length | | | | | | |
| | (cm) | | | | | | |
| | Flame | 0 | 0 | 2 | 1 | 0 | 0 |
| | contact | | | | | | |
| | frequency | | | | | | |
| | (times) | | | | | | |
| NOx removal | | 10.63 | 10.60 | 9.7 | 10.5 | 10.1 | 7.18 |
| efficiency (%) | | | | | | | |
| Visible light | | 52.4 | 41.8 | 52.0 | 52.1 | 51.5 | 49.9 |
| transmittance (%) | | | | | | | |

As appreciated from Table 1, the titanium dioxide-filled nano dustproof window screen fabricated through the first embodiment has the most excellent dust collection efficiency, air ventilation, flame-resistant performance, NOx removal efficiency, and visible light transmittance among the titanium dioxide-filled nano dustproof window screens fabricated through the first to fifth embodiments and the first comparison example.

As mentioned above, the preferred embodiment of the present inventive concept has been disclosed in the specification and drawings. In the description of the present inventive concept, special terms are used not to limit the present inventive concept and the scope of the present inventive concept as defined in claims, but just to explain the present inventive concept. Therefore, persons skilled in the relevant art can appreciate that many modifications and variations are possible in light of the above teachings. It is therefore intended that the scope of the inventive concept be limited not by this detailed description, but rather by the claims appended hereto.

1. A titanium dioxide-filled nano dustproof window screen comprising a first fabric, a nanofiber web, and a second fabric laminated on top of one another, wherein the nanofiber web comprises polyvinylidene fluoride and reduced titanium dioxide.

2. The titanium dioxide-filled nano dustproof window screen according to claim 1, wherein the nanofiber web comprises the polyvinylidene fluoride and the reduced titanium dioxide mixed by weight in the ratio of 1:0.05 to 0.3.

3. The titanium dioxide-filled nano dustproof window screen according to claim 1, wherein the first fabric is made of polyacrylonitrile (PAN) carbon fibers coated with polyvinyl chloride having a weight-average molecular weight in the range between 38,000 and 58,000 in such a way as to be woven to have a square mesh pattern.

4. The titanium dioxide-filled nano dustproof window screen according to claim 1, wherein the first fabric has an opening rate of 55 to 75% and the second fabric has an opening rate of 25 to 45%.

5. The titanium dioxide-filled nano dustproof window screen according to claim 1, wherein the nanofiber web is produced through electrospinning in which the reduced titanium dioxide is contained in the polyvinylidene fluoride.
